(19) United States
(12) Patent Application Publication
(10) Pub. No.: US 2026/0236502 A1
(43) Pub. Date: Aug. 13, 2026

(54) Temporal GraphRAG

(71) Applicant: Microsoft Technology Licensing, LLC, Redmond, WA (US)

(72) Inventors: Darren Keith EDGE, Southwick, MA (US); Jonathan Karl LARSON, Bremerton, WA (US); Thu Ha TRINH, Cambridge (GB)

(73) Assignee: Microsoft Technology Licensing, LLC, Redmond, WA (US)

(21) Appl. No.: 19/047,999

(22) Filed: Feb. 7, 2025

(51) Int. Cl. G06F 16/3329; G06F 16/334; G06F 16/34; G06F 16/901

(52) U.S. Cl. CPC G06F 16/33295; G06F 16/3347; G06F 16/345; G06F 16/9024

(57) ABSTRACT

The description relates to providing meaningful information relating to a dataset, especially a dynamic dataset that changes over time. One example can obtain text chunks of the dataset grouped by period and extract concepts from the text chunks by period. The example can induce the extracted concepts into a graph structure and detect period communities in the graph structure of individual periods. The example can create period summaries from the detected period communities and determine whether a user query relates to specific periods and/or communities. Where the user query relates to specific periods and/or communities, the example can obtain text answers by mapping the query over relevant period text chunks or relevant period community summaries. The example can obtain a final answer for the user query from the obtained text answers.

### BACKGROUND

Retrieval augmented generation (RAG) techniques are the cornerstone of grounding LLMs to domain-specific data by performing similarity searches over embeddings stored in vector databases.

### SUMMARY

This patent relates to providing meaningful information relating to a dataset, especially a dynamic dataset that changes over time. One example can obtain text chunks of the dataset grouped by period and extract concepts from the text chunks by period. The example can induce the extracted concepts into a graph structure and detect period communities in the graph structure of individual periods. The example can create period summaries from the detected period communities and determine whether a user query relates to specific periods and/or communities. Where the user query relates to specific periods and/or communities, the example can obtain text answers by mapping the query over relevant period text chunks or relevant period community summaries. The example can obtain a final answer for the user query from the obtained text answers.

Another example can obtain text chunks of a dataset from a first period and extract entity and/or concept graphs for the first period. This example can detect communities in the text chunks of the first period and create a first summary from the detected communities of the first period. This example can obtain text chunks of the dataset from a subsequent period and extract entity and/or concept graphs for the subsequent period and not for the first period. The example can detect communities in the text chunks of the subsequent period and create a second summary from the detected communities of the subsequent period. The example can create an overall summary from the first summary and the second summary.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIGS. 1A-1C and 7 illustrate example systems that are consistent with some implementations of the present concepts.

FIGS. 2-4, 5A, 5B, and 6A-6E illustrate example flowcharts that are consistent with some implementations of the present concepts.

FIG. 8 shows an example generative language model that is consistent with some implementations of the present concepts.

### DETAILED DESCRIPTION

The present concepts relate to leveraging generative artificial intelligence models (hereinafter, “generative models’) to provide useful information relating to a dataset. As used herein, the dataset can be previously unseen by the generative models during training. For example, the dataset can be a private or internally available dataset. Example generative models include large language models (LLM), small language models (SLM), and/or foundation/transformer models, among others.

Retrieval augmented generation (RAG) techniques are the cornerstone of grounding LLMs to private datasets (e.g., domain-specific data) by performing similarity search over embeddings stored in vector databases. However, existing RAG techniques fail at intricate analytical tasks and are heavily dependent on the user’s working knowledge of the dataset to determine what to query. They also fail to provide facilities that can accurately perform aggregate reasoning across complex questions. In unfamiliar and rapidly evolving data sources, the challenge is even greater for the end user.

Graph-enabled retrieval-augmented generation (RAG) (e.g., GraphRAG) addresses these deficiencies by creating graphs of entities (e.g., nodes), relationships (e.g., edges), and frequencies (of the relationships) (e.g., weight) contained in the dataset. Summaries of the graphs allow LLMs to generate more meaningful responses to user queries relating to the dataset.

Full GraphRAG is a "breadth first" approach that addresses this limitation by building a data index based on graph-community summaries in advance of the query stage. This data index is built in several stages: first, entity and relationship observations are extracted from text chunks; second, all observations of an entity or relationship are aggregated and summarized; third, entity and relationship summaries defining a graph community are themselves summarized to produce a community summary. Given a user query, all community summaries are used to answer the query in batch-map-filter-reduce style. A limitation of this approach is that there is no clear way to update the community summaries in an efficient way in a streaming data context, or use only a relevant subset of communities to generate the final answer.

The present concepts relate to temporal GraphRAG, which is a form of GraphRAG that addresses a temporally changing dataset, such as a streaming dataset. Temporal GraphRAG can analyze streaming data in a systematic and comprehensive way via multi-level data summaries in both time and topic dimensions, supporting efficient and effective time-based querying using more relevant community summaries and in some cases only the most relevant community summaries.

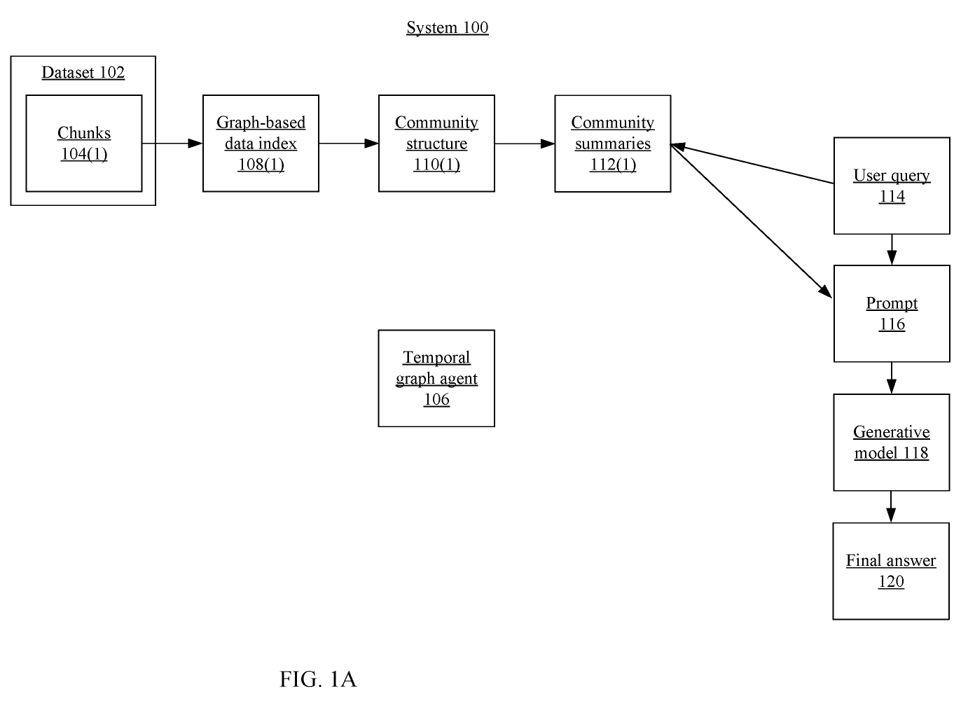

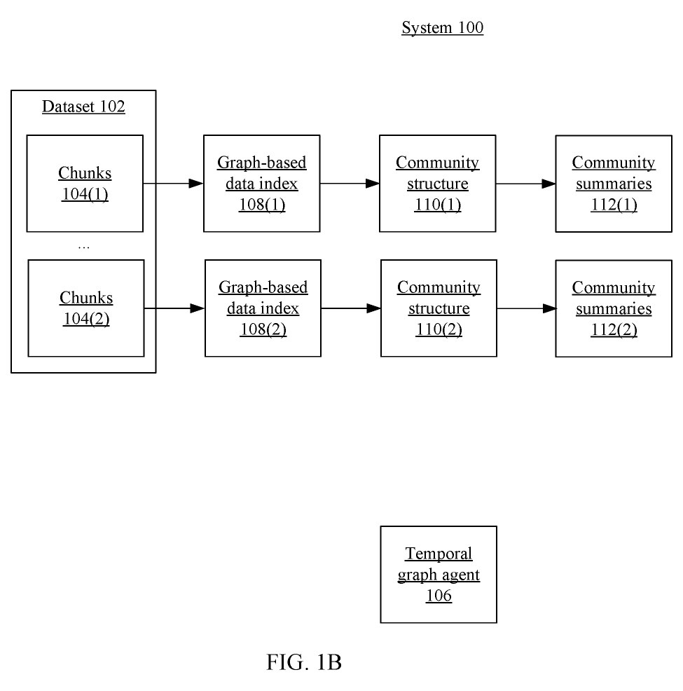

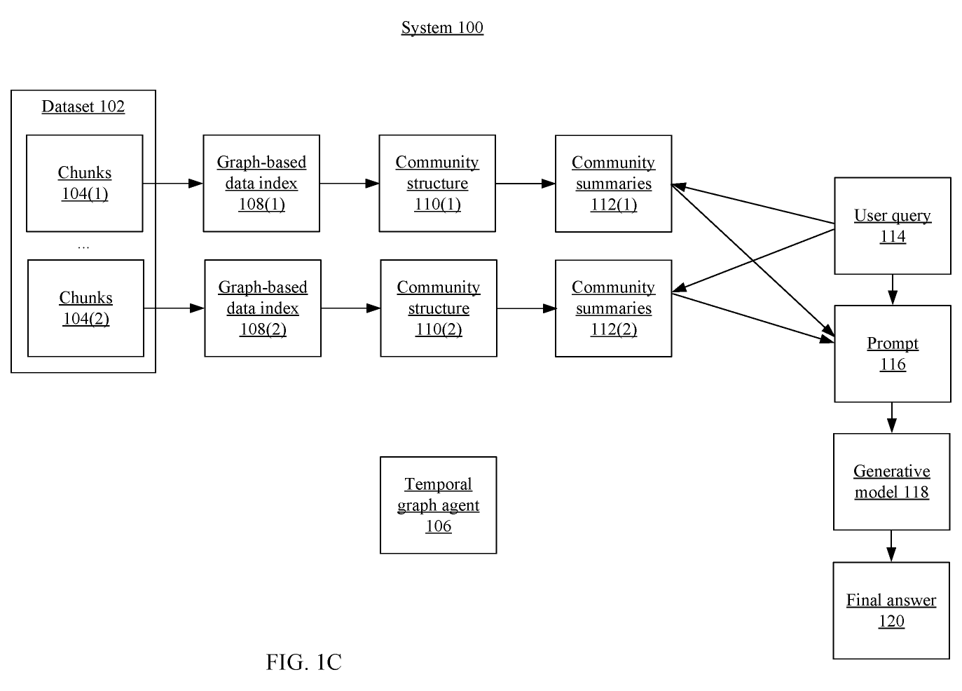

Temporal GraphRAG provides a technical solution by creating a graph-based data index that supports hierarchical aggregation of data summaries in both time and topic dimensions. An initial graph-based data index can be created for the dataset. Subsequently, the graph-based data index can be updated. The graph-based data index can be updated at regular time intervals/periods (e.g., time windows), such as days, weeks, and/or months. Alternatively, the graph-based data index can be updated, upon the occurrence of a condition, such as more data being added to the dataset. Stated another way, adding or receiving additional data in the dataset can trigger a new period. One of the novel aspects is that the updating can be performed on the new data rather than recreating the graph-based data index from all of the data (e.g., the existing data of the dataset and the new data of the dataset). This technical solution of updating the graph-based data index to reflect the new data saves vast computing resources compared to recreating the graph-based data index from an entirety of the dataset each time the data changes. One such example is explained below relative to FIGS. 1A-1C.

FIGS. 1A-1C collectively show an example temporal graphRAG system 100, which can implement some of the present concepts. In this case, the system 100 includes a dataset 102 that includes chunks 104(1) (e.g., chunks of the data of the dataset). A temporal graph agent 106 forms a graph-based data index 108(1) from the chunks 104(1). Temporal graph agent 106 forms a community structure 110(1) from the graph-based data index 108(1). Temporal graph agent 106 forms community summaries 112(1) from the community structure 110(1). At this point, when a user query 114 is received relating to the dataset 102, temporal graph agent 106 uses the community summaries 112(1) to augment the user query to formulate a prompt 116 to a generative model 118. The prompt 116 can allow the generative model 118 to generate a more relevant final answer 120 for the dataset than could otherwise be obtained.

FIG. 1B shows system 100 at a subsequent point where additional chunks 104(2) have been added to the dataset 102. Temporal graph agent 106 forms another graph-based data index 108(2) for the additional chunks 104(2). Similarly, temporal graph agent 106 generates community structure 110(2) and community summaries 112(2) for the additional chunks 104(2). This process of creating additional graph-based data index 108(2), community structure 110(2), and community summaries 112(2) is much less resource intensive than creating entirely new graph-based data indexes, community structures, and community summaries that cover the entire dataset 102.

In some implementations, the additional graph-based data index 108(2), community structure 110(2), and/or community summaries 112(2) can be separate and distinct from the earlier graph-based data index 108(1), community structure 110(1), and community summaries 112(1). Alternatively, the additional graph-based data index 108(2), community structure 110(2), and/or community summaries 112(2) can entail the earlier graph-based data index 108(1), community structure 110(1), and community summaries 112(1) updated to reflect the additional chunks 104(2).

FIG. 1C shows that when a subsequent user query 114 is received, temporal graph agent 106 can leverage both community summaries 112(1) and 112(2) to generate prompt 116 for generative model 118. The resultant final answer 120 can be more relevant than could be obtained without the community summaries 112(1) and 112(2) and/or just the original community summary 112(1). Thus, system 100 offers a technical solution that achieves improved results while consuming fewer resources than existing techniques.

From another perspective, the present technical solution includes generative model memory structures built over the top of the dataset on a period-by-period basis. This arrangement gives a holistic understanding of the data to the generative model before receiving the user query. This arrangement allows the generative model to provide as good as or even better answers as existing techniques while using fewer computing resources than existing techniques.

Viewed another way, in some implementations user queries and (period) community summaries are both embedded. Community summaries are then ranked by vector similarity to the query, and an LLM is used to determine a set of relevant summaries. The LLM is then used again to map the user query over relevant summaries and then the LLM is used a final time to reduce these partial answers into a final answer.

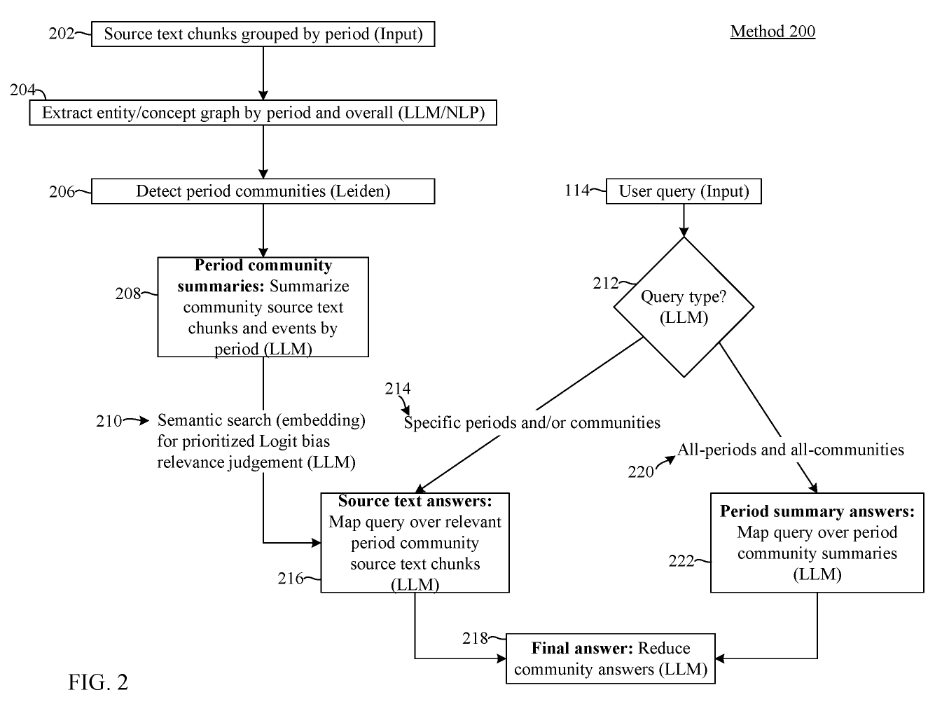

FIGS. 2-4 describe example temporal graphRAG methods.

FIG. 2 relates to method 200. Block 202 obtains source text chunks of a dataset grouped by period. As mentioned above, in a first period the dataset can include a first set of data chunks and in a second or subsequent period, additional or new data chunks can be added to the dataset. This process can be repeated for any number of periods.

Block 204 extracts entity/concept graphs by period and overall from the text chunks. The extraction can be performed with various tools, such as LLMs and/or natural language processing (NLP). Block 206 detects period communities. Various algorithms, such as the Leiden algorithm can be employed. Block 208 creates period summaries, which summarize community source text chunks and events by period. Various tools can be utilized to obtain the period summaries. For instance, an LLM or other generative model can identify the period summaries.

Block 210 relates to performing semantic search for prioritized Logit bias relevance judgement. Viewed from another perspective, block 210 can rank period community summaries by vector similarity to the user query. The LLM can then be employed to judge relevance of period community summaries in rank order, returning relevant chunks after (a number) ‘k’ successive irrelevance judgements. Briefly, semantic search is search with meaning (e.g., inter-relatedness). Here the semantic search operates on embeddings (e.g., vector representations (e.g., tokens)) of words/objects in the source text chunks. The embeddings convey relationship information of the embedded words or tokens. Logit bias can be utilized to tune the similarity of individual tokens (e.g., increase or decrease a likelihood of the individual tokens appearing in the search results) relating to the community source text chunks.

The method now turns to receiving the user query 114 (e.g., input). Block 212 investigates the query type. This aspect can involve various tools. For instance, one technique can utilize the LLM or other generative model to determine the query type relative to subject matter and/or relevant time period(s). As indicated at 214, when or where the user query relates to specific periods and/or communities, the method turns to block 216.

Block 216 obtains source text answers by mapping the query over relevant period community source text chunks. The generative model, such as the LLM can be used to obtain the source text answers. This can be used to generate the final answer at 218, which is analogous to the final answer 120 of FIG. 1C. The final answer 218 reduces community source text chunks to provide a concise and relevant answer. The final answer can be generated by the generative model (e.g., LLM).

Returning to 212, when the query type relates to all periods and all communities at 220, the method proceeds to block 222. This block obtains period summary answers, which map the query over the period community summaries. This block can be performed by the generative model, such as the LLM. The period summary answers can be used to formulate the final answer 218. Thus, method 200 provides a technical solution that applies GraphRAG indexing per period. For global queries, the technical solution uses period community summaries as inputs. For local (e.g., time- or topic-based) queries, the technical solution uses LLM relevance judgements to select communities to summarize via source texts. If there is a per-query token limit, the technical solution falls back to period summaries.

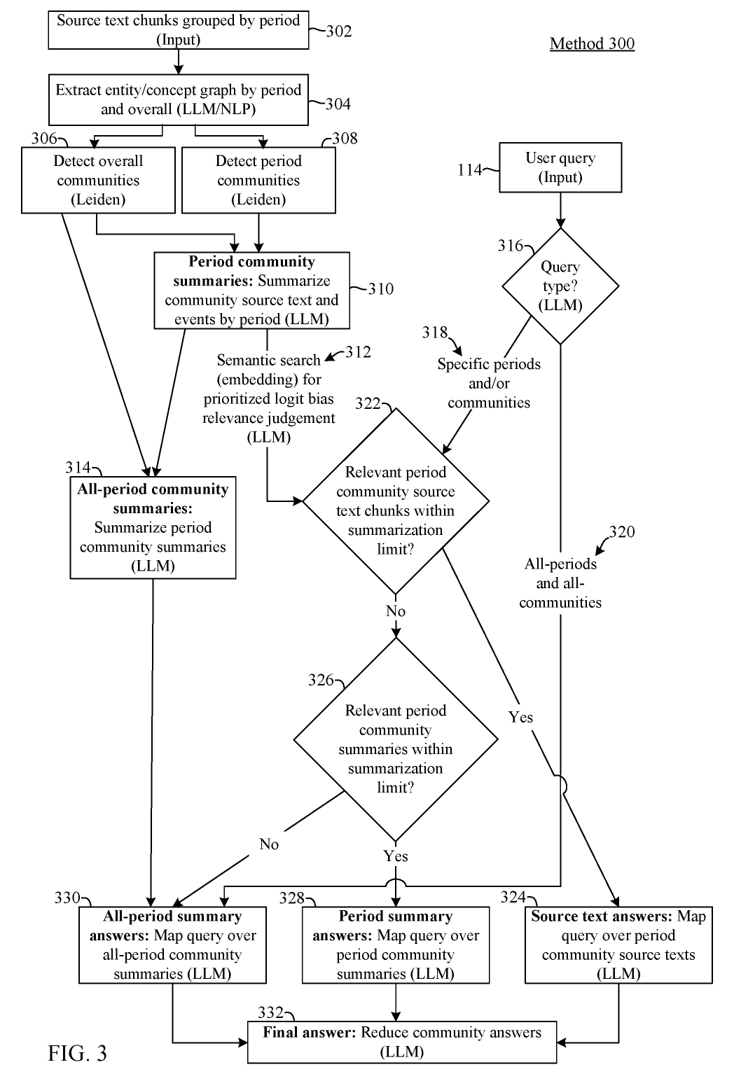

FIG. 3 relates to temporal GraphRAG method 300. Block 302 obtains source text chunks grouped by period. Block 304 extracts entity/concept graphs by period and overall, such as with LLMs or NLP. The output of the extraction is provided to blocks 306 and 308. Block 306 detects overall communities (e.g., communities that bridge multiple periods of data chunks), such as with the Leiden algorithm. Block 308 detects period communities (e.g., communities within data chunks of an individual period), such as with the Leiden algorithm. The output of blocks 306 and 308 (e.g., community structures) is utilized by block 310.

Block 310 generates period community summaries. The community summaries function to summarize the community source text and events for individual periods. Block 310 can be performed by a generative model, such as an LLM. At block 312, semantic search is performed on the community summaries (e.g., the output of block 310). The semantic search (e.g., embeddings) relates to relevance, and specifically for prioritized Logit bias relevance judgement. The semantic search can be performed by a generative model, such as an LLM. The output of block 312 will be discussed further below. Now the description turns to block 314.

Block 314 receives the overall communities from block 306 and the period community summaries from block 310. Block 314 generates all-period community summaries, which as the name suggests, summarizes across period community summaries. This block can be performed by a generative model, such as an LLM.

The method description now turns to real-time (e.g., query time) where user query 114 is received as input. Block 316 determines the query type. This block can be performed by a generative model, such as an LLM. The determination can indicate that the query type relates to specific periods and/or communities as indicated at 318 or all-periods and all communities as indicated at 320. When the query type relates to specific periods and/or communities, the method turns to block 322.

Block 322 receives the sematic search of block 312 and determines whether relevant period community source texts are within summarization limits. If yes, the method proceeds to block 324, if not, the method proceeds to block 326. Block 324 generates source text answers, which map the query over period community source texts. This block can be performed by a generative model, such as an LLM.

The method proceeds to block 326 responsive to a ‘no’ answer at block 322. Block 326 queries whether the relevant period community summaries are within the summarization limit. If yes, the method proceeds to block 328. If no, the method proceeds to block 330. Block 328 provides period summary answers by mapping the user query over period community summaries. This block can be performed by a generative model, such as an LLM.

The method proceeds to block 330 with a ‘no’ answer at block 326. Block 330 receives the all-period community summaries of block 314. Block 330 generates all-period summary answers by mapping the user query over all-period community summaries. This block can be performed by a generative model, such as an LLM.

The method now turns to block 332 to generate final answers, by reducing community answers. Block 332 receives input from blocks 324, 328, and/or 330 to produce the final answer (analogous to final answer 120 of FIG. 1C and final answer 218 of FIG. 2). This block can be performed by a generative model, such as an LLM. This final answer can be presented to the user, such as via a user interface (UI). The final answer can be at least as (and likely more) accurate as existing techniques while consuming fewer processing resources than existing techniques.

Method 300 provides dynamic input scoping based on relevant communities from the dataset. This method also uses source texts if possible, otherwise the method uses individual period community summaries or all period community summaries to augment the user query into a highly performant prompt. The highly performant prompt fits within prompt token limits and produces a highly relevant final answer to the querying user.

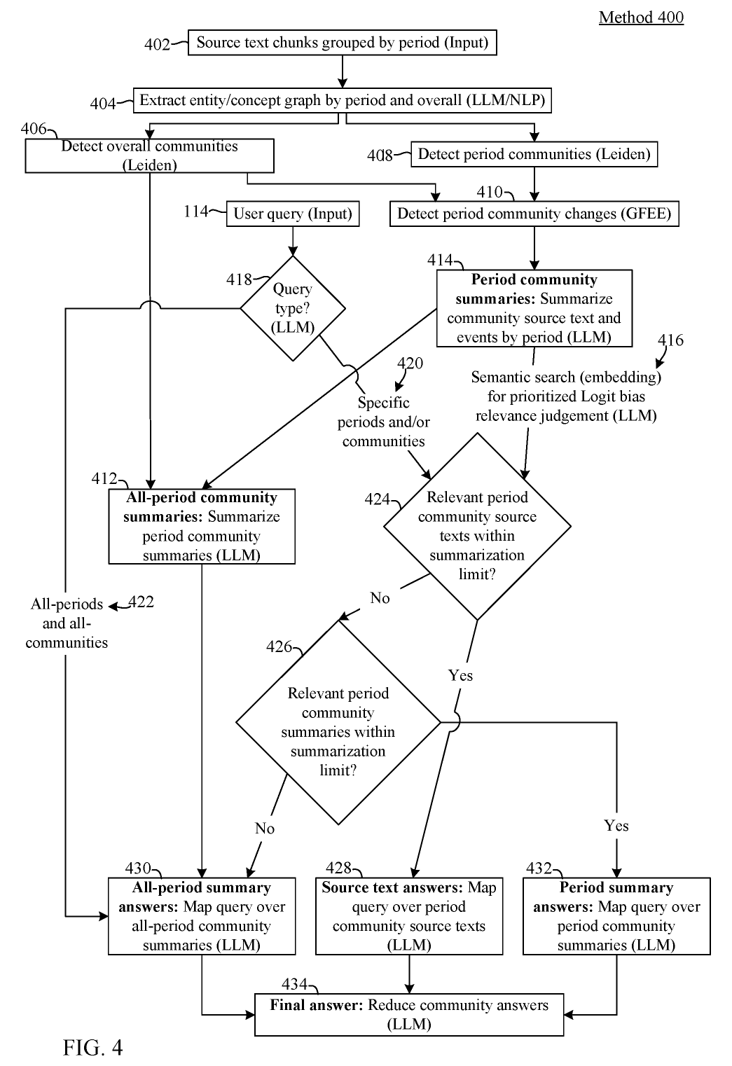

FIG. 4 relates to temporal GraphRAG method 400. Block 402 obtains source text chunks grouped by period. Block 404 extracts entity/concept graphs by period and overall, such as with LLMs or NLP. The output of the extraction is provided to blocks 406 and 408. Block 406 detects overall communities, such as with the Leiden algorithm. The output of block 406 supplies blocks 410 and block 412. Block 408 detects period communities, such as with the Leiden algorithm. The output of block 408 is supplied to block 410.

Block 410 detects period community changes via graph fusion encoder embedding (GFEE). The period community changes are utilized by block 414 to generate period community summaries, which summarize community source text and events by period. This block can be performed by a generative model, such as an LLM. The output of block 414 is sent to block 412. The output is also used at block 416 for semantic search (e.g., embedding) for prioritized Logit bias relevance judgement. Block 416 can be performed by the generative model, such as an LLM.

Block 412 utilizes the output of block 406 (e.g., overall communities) and the output of block 414 (e.g., period community summaries) to generate all-period community summaries. The all-period community summaries summarize period community summaries and can be generated by the generative model, such as an LLM.

At query time, a user query 114 is received. Block 418 identifies the query type. The query type can relate to specific periods and/or communities as indicated at 420 or all periods and all communities as indicated at 422. Stated another way, the query type indicates whether the relevant text is associated with an individual period or community or across communities and/or periods.

Block 424 receives the semantic search of block 416 and the query relating to specific periods and/or communities 420 and determines whether relevant period community source texts are within a summarization limit. If no, the method proceeds to block 426. If yes, the method proceeds to block 428.

Block 426 determines whether relevant period community summaries are within the summarization limit. If no, the method proceeds to block 430. If yes, the method proceeds to block 432.

The method covers each potential scenario with blocks 428, 430, and 432. Block 428 provides source text answers that map the query over period community source texts. Block 430 provides all-period summary answers that map the query over all-period community summaries. Block 432 provides period summary answers that map the query over period community summaries. The output of blocks 428-432 can serve as input to block 434 that generates the final answer by reducing community answers. Each of these blocks 428-434 can be performed by the generative model, such as an LLM.

Method 400 provides a technical solution by adding the use of graph fusion encoder embedding (GREE) to detect behavioral shifts for entities, relationships, and communities. This technical solution allows ranking of different communities at the same time (e.g., individual period) and the same community at different times (e.g., over duration of dataset) by the degree of behavior change. The technical solution can add associated insights to summaries and prioritize source texts accordingly.

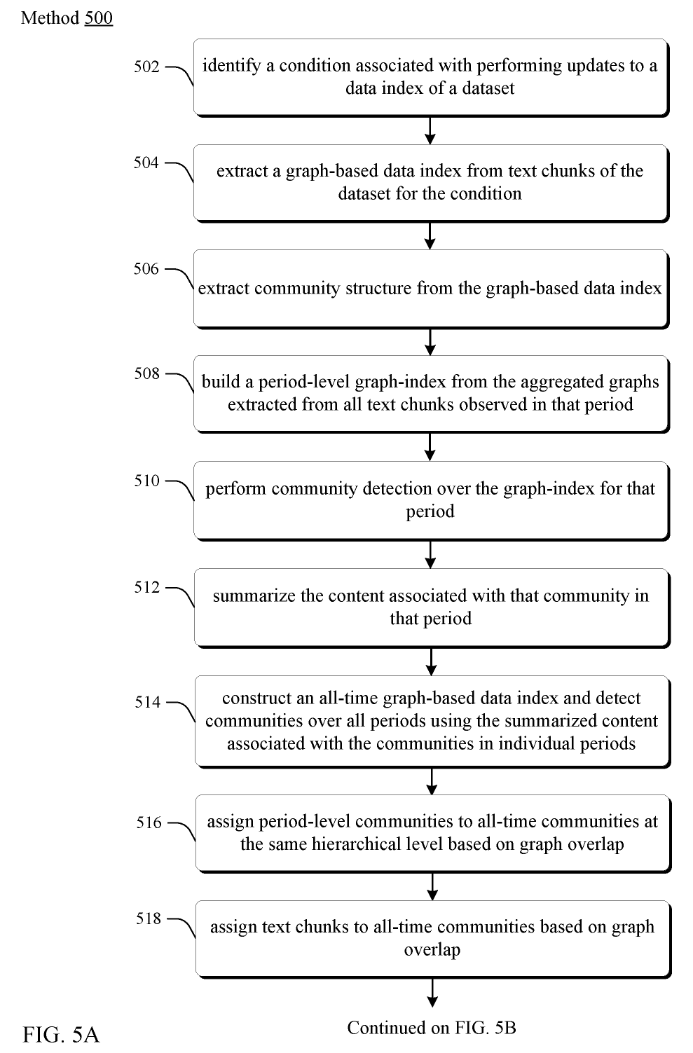

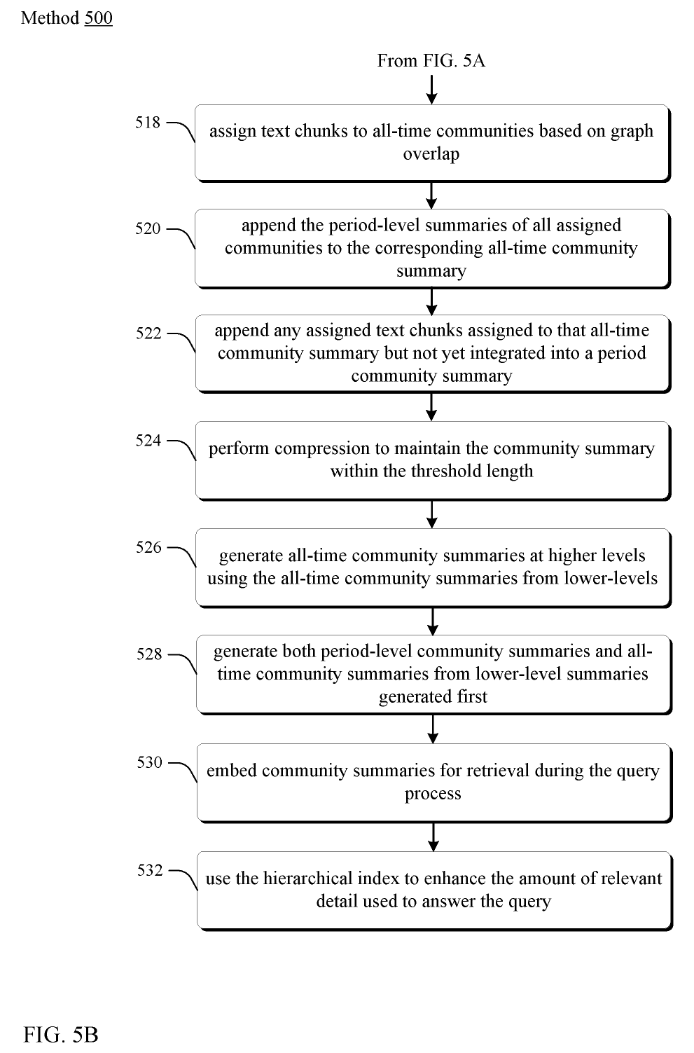

FIGS. 5A and 5B relate to temporal GraphRAG method 500. Block 502 can identify a condition associated with performing updates to a data index of a dataset. For instance, the condition could be additional data added to the data index. Another example can relate to expiration of time windows (e.g., periods) which are built over streaming data sources, such as days, weeks, months (e.g., the dataset is a dynamic dataset that changes over time).

Block 504 can extract a graph-based data index from text chunks of the dataset for the condition (e.g., the period). In cases where the dataset relates to streaming data files the extracting can relate to extracting entities and relationships using an LLM and/or extracting concept co-occurrence using noun phrase identification.

Block 506 can extract community structure from the graph-based data index, such as by using Leiden hierarchical community detection.

Block 508, within each condition, such as each time window, can build a period-level graph-index from the aggregated graphs extracted (e.g., the extracted community structure) from all text chunks observed in that period.

Block 510, at the end of each time window, can perform community detection over the graph-index for that period. These communities represent topics in the dataset, and if hierarchical community detection is used, the hierarchical topic structure of the dataset.

Block 512, for each period-level community, can summarize the content associated with that community in that period (e.g., from the community detection). The summarizing can be accomplished using an LLM to summarize all text chunks used to create the period-level summary or entity/relationship summaries.

In some variations, graph statistics (e.g., graph fusion encoder embedding) may be used to detect changes in the patterns of node (entity/concept) relationships that are salient with respect to all global changes. LLM summaries of these changes may be added to period summaries for additional context.

Block 514 can construct an all-time graph-based data index and detect communities over all periods using the summarized content associated with the communities in individual periods.

Block 516 can assign period-level communities to all-time communities at the same hierarchical level based on graph overlap (e.g., greatest number or proportion of overlapping nodes and edges).

Block 518 can assign text chunks to all-time communities based on graph overlap (e.g., greatest number or proportion of overlapping nodes and edges).

Block 520, for all completed time windows, can append the period-level summaries of all assigned communities to the corresponding all-time community summary.

Block 522, for the current time window in progress, can append any assigned text chunks assigned to that all-time community summary but not yet integrated into a period community summary.

Block 524, when all-time community summaries reach a predefined threshold length, can perform compression to maintain the community summary within the threshold length. In one example the compression can entail first-in first-out period elimination, uniform summarization of all periods, period summarization with a recency detail bias, etc.

In instances when there are multiple time windows of interest, block 526 can generate all-time community summaries at higher levels (e.g., week-level summaries) using the all-time community summaries from lower-levels (e.g., day-level summaries), rather than from input text chunks or entity and relationship summaries.

Block 528, when a hierarchical community detection method is used (e.g., Leiden), can generate both period-level community summaries and all-time community summaries from previously generated lower-level summaries.

Block 530 can embed (all (or most)) community summaries for retrieval during the query process.

Block 532 can use the hierarchical index to enhance (and potentially maximize) the amount of relevant detail used to answer the query. Thus, pertinent data identified from the period and community summaries can populate a prompt to answer the query (e.g., to produce a final answer).

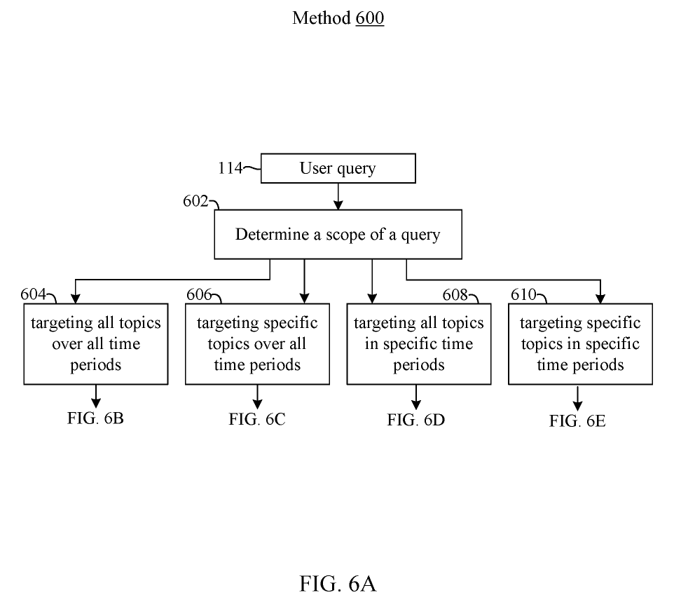

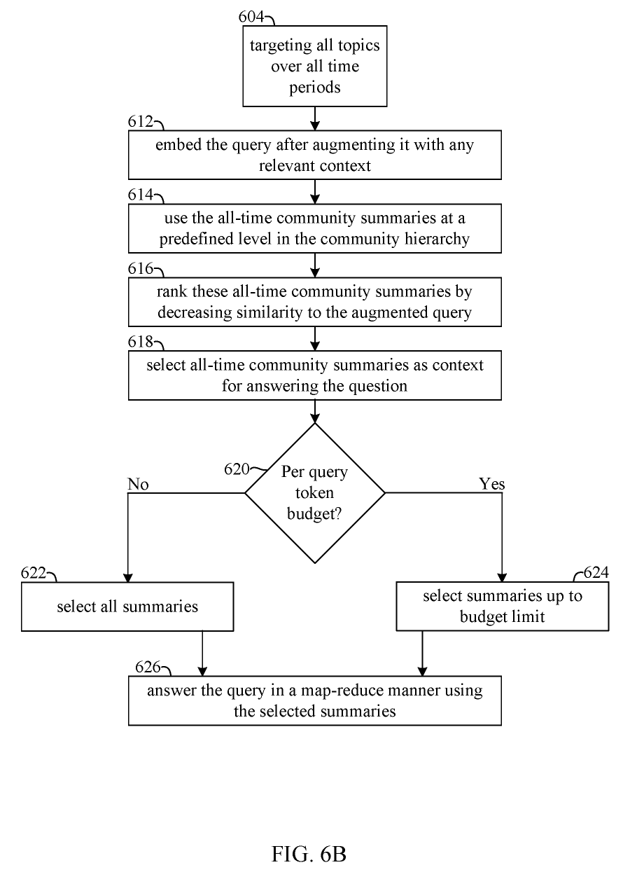

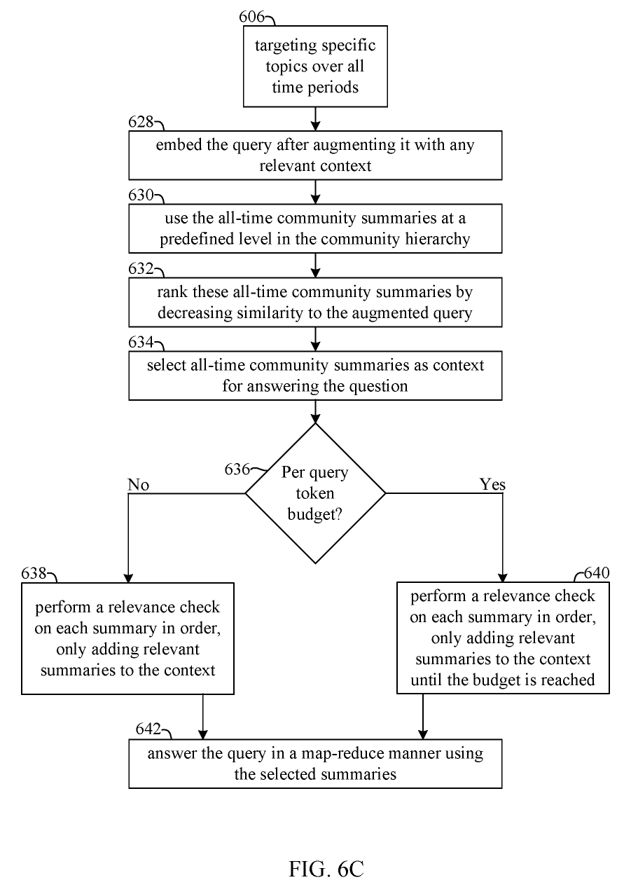

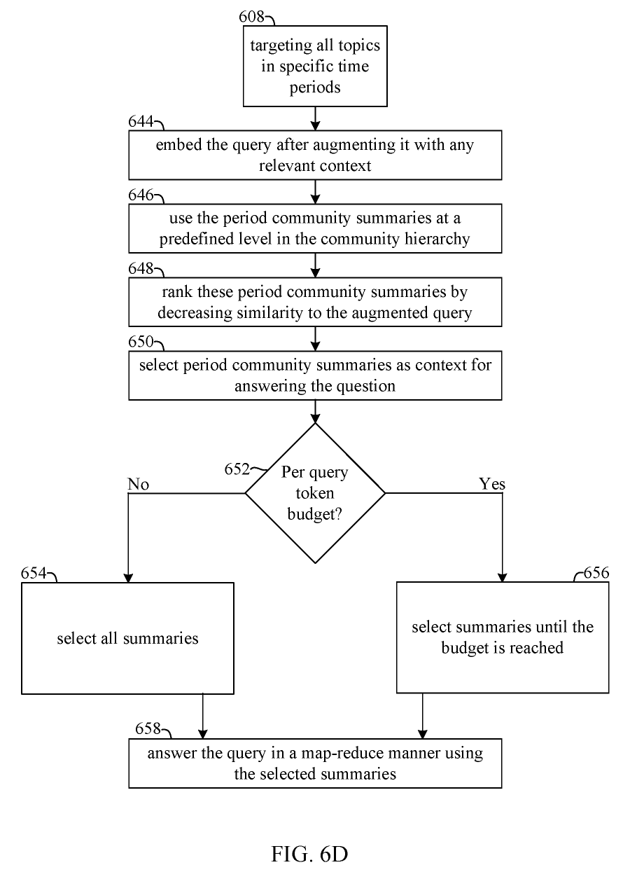

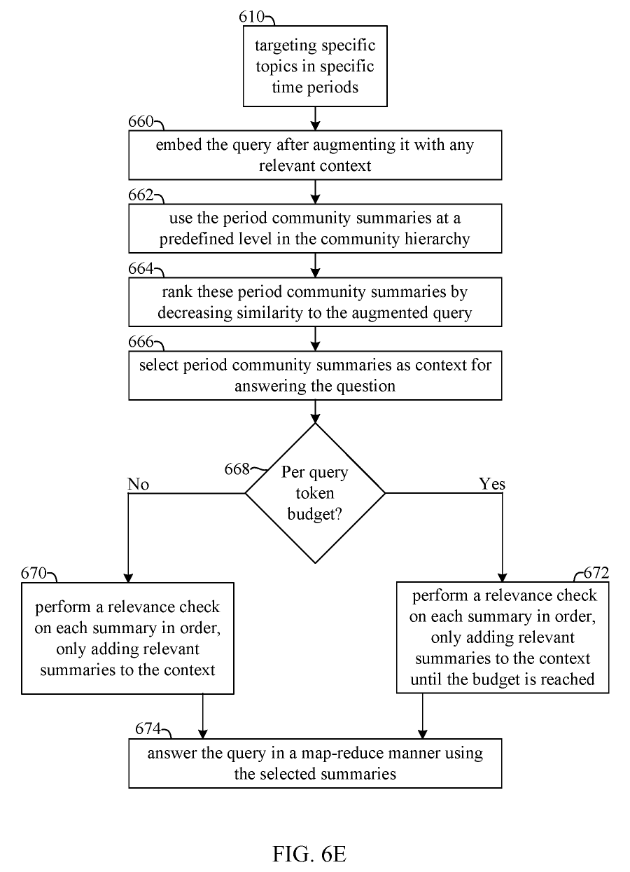

FIGS. 6A-6E collectively relate to a query time temporal GraphRAG method 600. The method starts by receiving a user query 114. Block 602 can determine a scope of the user query. For instance, the generative model, such as the LLM can be utilized to determine the scope of the user query. The scope can be characterized in various ways. One scope characterization scheme characterizes the scope as targeting all topics over all time periods as indicated at 604, targeting specific topics over all time periods as indicated at 606, targeting all topics in specific time periods as indicated at 608, or targeting specific topics in specific time periods as indicated at 610.

FIG. 6B expands on the scenario where the query is targeting all topics over all time periods at 604.

Block 612 can embed the user query after augmenting it (e.g., the query) with any relevant context (e.g., the current date).

Block 614 can use the all-time community summaries at a predefined level in the community hierarchy (e.g., root/level 0, level 1, etc.). For example, for each time period, the method can retrieve all relevant community summaries. The method may do this at a predefined level, but it may also use text embedding nearest neighbors to help quickly find relevance - regardless of community level.

Block 616 can rank these all-time community summaries by decreasing similarity to the augmented user query of block 612.

Block 618 can select all-time community summaries. Block 620 can use the selected all-time community summaries as context for answering the question whether there is a per-query token budget.

If there is no per-query token budget (e.g., no at block 620), block 622 can select all community summaries. If there is a per-query token budget (e.g., yes at block 620), block 624 can select community summaries up to this budget limit. Some implementations do not perform relevance checks because the query scope suggests everything is relevant. The relevance checks provide a mechanism to allow throttling on how many calls the method makes to the LLM - thus forming a query budget of sorts. When the method is attempting to generate the answer, it continues generating until it has the relevant answer or it hits this budget limitation.

Block 626 can answer the user query in a map-reduce manner using the selected summaries.

Referring to FIG. 6C, the description now returns to targeting specific topics over all time periods as indicated at 606 of FIG. 6A.

Block 628 can embed the query after augmenting it (e.g., the query) with any relevant context (e.g., the current date).

Block 630 can use the all-time community summaries at a predefined level in the community hierarchy (e.g., root/level 0, level 1, etc.). For example, for each time period, the method can retrieve all relevant community summaries. The method may do this at a predefined level, but it may also use text embedding nearest neighbors to help quickly find relevance - regardless of community level.

Block 632 can rank these all-time community summaries by decreasing similarity to the augmented query.

Block 634 can select all-time community summaries.

Block 636 can determine if there is a per query token budget.

If there is no per-query token budget (e.g., no at block 636), block 638 can perform a relevance check on each community summary in order.

If there is a per-query token budget (e.g., yes at block 636), block 640 can perform a relevance check on each community summary in order, only adding relevant community summaries to the context until the budget is reached. These relevance checks ensure that only community summaries that definitely match the specific topics of the query are included. In some implementations, a specified number of successive irrelevant queries can be used to terminate the context building early and proceed to answer generation at 642.

Block 642 can answer the query (e.g., produce a final answer) in a map-reduce manner using the selected community summaries.

In reference to FIG. 6D, the description now returns to targeting all topics in specific time periods as indicated at 608 of FIG. 6A.

Block 644 can embed the query after augmenting it (e.g., the query) with any relevant context (e.g., the current date).

Block 646 can use the period community summaries at a predefined level in the community hierarchy (e.g., root/level 0, level 1, etc.)

Block 648 can rank these period community summaries by decreasing similarity to the augmented query.

Block 650 can select period community summaries as context for answering the query of block 652.

Block 652 determines whether there is a per query token budget.

If there is no per-query token budget (e.g., no at block 652), block 654 can select all community summaries.

If there is a per-query token budget (e.g., yes at block 652), block 656 can select community summaries up to this budget limit. At this point, the method does not perform relevance checks since the query scope suggests everything is relevant.

Block 658 can answer the query in a map-reduce manner using the selected community summaries.

In reference to FIG. 6E, the description now returns to targeting specific topics in specific time periods as indicated at 610 as introduced on FIG. 6A.

Block 660 can embed the query after augmenting it (e.g., the query) with any relevant context (e.g., the current date).

Block 662 can use the period community summaries at a predefined level in the community hierarchy (e.g., root/level 0, level 1, etc.).

Block 664 can rank these period community summaries by decreasing similarity to the augmented query.

Block 666 can select period community summaries as context for answering the question of block 668 regarding a per query token budget.

Block 668 can determine whether there is a per query token budget.

If there is no per-query token budget (e.g., no at block 668), block 670 can perform a relevance check on each summary in order, only adding relevant summaries to the context.

If there is a per-query token budget (e.g., yes at block 668), block 672 can perform a relevance check on each summary in order, only adding relevant summaries to the context until the budget is reached. These relevance checks ensure that only summaries that definitely match the specific topics of the query are included. Some implementations can use a specified number of successive irrelevant queries to terminate the context building early and proceed to answer generation.

Further, if a per-query token budget is set and the context created to answer the question is less than this budget, then summaries can be progressively expanded in rank order to provide more relevant detail up to the limit. For instance, first, all-time community summaries can be expanded into their associated period community summaries. Second, period community summaries can be expanded into their associated text units (e.g., source text chunks or entity/relationship summaries).

Block 674 can answer the query in a map-reduce manner using the selected summaries.

The order in which the disclosed methods are described is not intended to be construed as a limitation, and any number of the described acts can be combined in any order to implement the method, or an alternate method. Furthermore, the methods can be implemented in any suitable hardware, software, firmware, or combination thereof, such that a computing device can implement the method. In one case, the methods are stored on one or more computer-readable storage medium/media as a set of instructions such that execution by a processor of a computing device causes the computing device to perform the method.

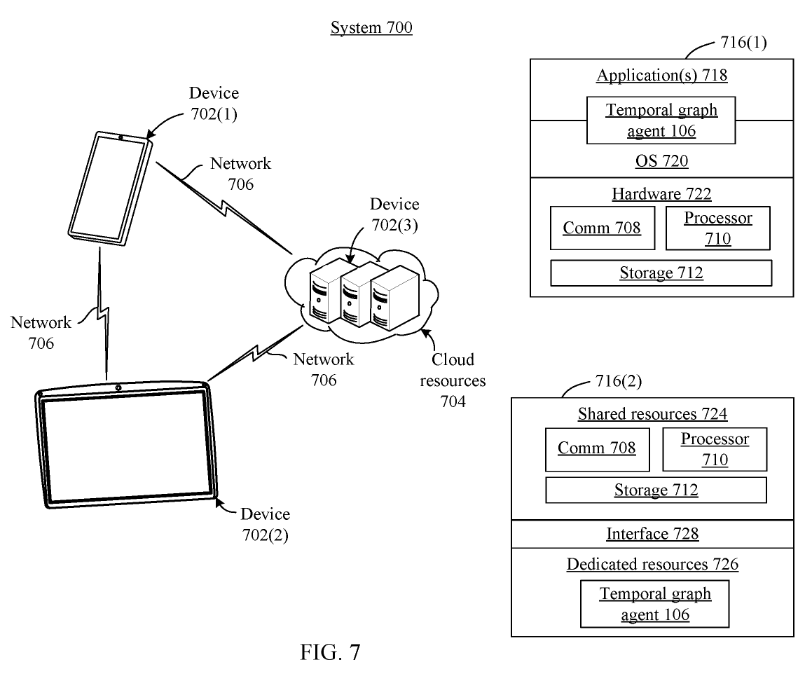

FIG. 7 shows another example temporal GraphRAG system 700. System 700 can include computing devices 702. In the illustrated configuration, computing device 702(1) is manifest as a smartphone, computing device 702(2) is manifest as a tablet type device, and computing device 702(3) is manifest as a server type computing device, such as may be found in a datacenter such as a cloud resource 704. Computing devices 702 can be coupled via one or more networks 706 that are represented by lightning bolts. In some cases, some of the computing devices 702 can function as edge devices between other computing devices.

Computing devices 702 can include a communication component 708, a processor 710, storage resources (e.g., storage) 712, and/or temporal graph agent 106. The temporal graph agent 106 can be implemented as an application, framework, and/or service. The temporal graph agent 106 can be implemented locally (e.g., on a user’s device), on an edge device, or remotely, such as in the cloud. The temporal graph agent 106 interacts with generative models. The generative models may be on the same device as the temporal graph agent 106 or a different device. For example, the generative models can be implemented locally (e.g., on a user’s device), on an edge device, and/or remotely, such as in the cloud.

Temporal graph agent 106 can access a dataset (FIG. 1, 102) (e.g., a private temporal dataset that changes over time). The temporal graph agent 106 can obtain text chunks of the dataset from a first period and extract entity and/or concept graphs for the first period. The temporal graph agent can detect communities in the text chunks of the first period and create a first summary from the detected communities of the first period. The temporal graph agent 106 can also obtain text chunks of the dataset from a subsequent period and extract entity and/or concept graphs for the subsequent period and not for the first period. The temporal graph agent can detect communities in the text chunks of the subsequent period and create a second summary from the detected communities of the subsequent period. The temporal graph agent creates an overall summary from the first summary and the second summary.

The temporal graph agent 106 can utilize the summaries from the first and second periods (and/or any additional periods) to augment user queries relating to the dataset. Toward this end, the temporal graph agent 106 can generate user interfaces (UIs). The UIs can be configured to present information to the user and/or receive information from the user. The temporal graph agent can leverage the subject matter and temporal aspects of the summaries to augment the user query received via the UI. The temporal graph agent can leverage generative models during the process and receive a final answer to the user query. The final answer can be presented via the UI. The final answer is both highly relevant to the user query and obtained with less resources than previous techniques.

FIG. 7 shows two device configurations 716 that can be employed by computing devices 702. Individual computing devices 702 can employ either of configurations 716(1) or 716(2), or an alternate configuration. (Due to space constraints on the drawing page, one instance of each configuration is illustrated). Briefly, device configuration 716(1) represents an operating system (OS) centric configuration. Device configuration 716(2) represents a system on a chip (SOC) configuration. Device configuration 716(1) is organized into one or more applications 718, operating system 720, and hardware 722. Device configuration 716(2) is organized into shared resources 724, dedicated resources 726, and an interface 728 therebetween.

In configuration 716(1), the temporal graph agent 106 can be manifest as part of the operating system 720. Alternatively, the temporal graph agent 106 can be manifest as part of the applications 718 that operate in conjunction with the operating system 720 and/or processor 710. In configuration 716(2), the temporal graph agent 106 can be manifest as part of the processor 710 or a dedicated resource 726 that operates cooperatively with the processor 710.

In some configurations, each of computing devices 702 can have an instance of the temporal graph agent 106. However, the functionalities that can be performed by the temporal graph agent 106 may be the same or they may be different from one another when comparing computing devices. For instance, in some cases, each temporal graph agent 106 can be robust and provide all of the functionality described above and below (e.g., a device-centric implementation).

In other cases, some devices can employ a less robust instance of the temporal graph agent 106 that relies on some functionality to be performed by another device.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

As mentioned above, device configuration 716(2) can be thought of as a system on a chip (SOC) type design. In such a case, functionality provided by the device can be integrated on a single SOC or multiple coupled SOCs. One or more processors 710 can be configured to coordinate with shared resources 724, such as storage 712, etc., and/or one or more dedicated resources 726, such as hardware blocks configured to perform certain specific functionality. Thus, the term “processor” as used herein can also refer to central processing units (CPUs), graphical processing units (GPUs), neural processing units (NPUs), field programable gate arrays (FPGAs), controllers, microcontrollers, processor cores, hardware processing units, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU, CPUs, GPU or GPUs). The program code can be stored in one or more computer-readable memory devices, such as computer-readable storage media. The features and techniques of the components are platform-independent, meaning that they may be implemented on a variety of commercial computing platforms having a variety of processing configurations.

### Machine Learning Overview

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

For the purposes of this document, the term “language model” refers to any type of automated agent that communicates via natural language. For instance, a language model can be implemented as a neural network, e.g., a decoder-based generative language model such as ChatGPT, a long short-term memory model, etc. The term “generative model,” as used herein, refers to a machine learning model employed to generate new content. Generative models can be trained to predict items in sequences of training data. When employed in inference mode, the output of a generative model can include new sequences of items that the model generates. Thus, a “generative language model” is a model that can generate new sequences of text given some input prompt, e.g., a query potentially with some additional context.

The term “prompt,” as used herein, refers to input text provided to a generative language model that the generative language model uses to generate output text. A prompt can include a query, e.g., a request for information from the generative language model. A prompt can also include context, or additional information that the generative language model uses to respond to the query.

The term “data health issue” refers to any characteristic of a dataset that could impact results of processing that dataset. Examples of data health issues include the presence of corrupted data, erroneous data, improperly formatted data, statistical outliers, etc. The term “data evaluation action” refers to any action performed on a dataset that can identify a data health issue. A “data evaluation plan” is one or more data evaluation actions that can be performed on a given dataset. A “data cleaning action” is an action that attempts to improve data quality by correcting at least one data health issue, e.g., by removing an entry or value from a dataset, changing a value in the dataset to a different value, etc.

A “summary” of a dataset refers to a representation of the dataset as a whole. A summary of a dataset can include data types of fields of the dataset, statistical information for fields of the dataset, and/or annotations of individual fields of the dataset, a set of fields of the dataset, or the dataset as a whole. A “data health score” refers to any metric that characterizes the presence of data health issues in a dataset. A “severity dictionary” is one or more indications of how severe a particular type of data health issue is when present in a dataset. For instance, a severity dictionary can indicate that missing values are relatively more severe than statistical outliers, and can include weights designating the relative severity of each.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards. The term “user-specific model” refers to a model that has at least one component that has been trained or constructed at least partially for a specific user. Thus, this term encompasses models that have been trained entirely for a specific user, models that are initialized using multi-user data and tuned to the specific user, and models that have both generic components trained for multiple users and one or more components trained or tuned for the specific user. Likewise, the term “application-specific model” refers to a model that has at least one component that has been trained or constructed at least partially for a specific application.

The term “pruning” refers to removing parts of a machine learning model while retaining other parts of the machine learning model. For instance, a large machine learning model can be pruned to a smaller machine learning model for a specific task by retaining weights and/or nodes that significantly contribute to the ability of that model to perform a specific task, while removing other weights or nodes that do not significantly contribute to the ability of that model to perform that specific task. A large machine learning model can be distilled into a smaller machine learning model for a specific task by training the smaller machine learning model to approximate the output distribution of the large machine learning model for a task-specific dataset.

### Example Decoder-Based Language Model

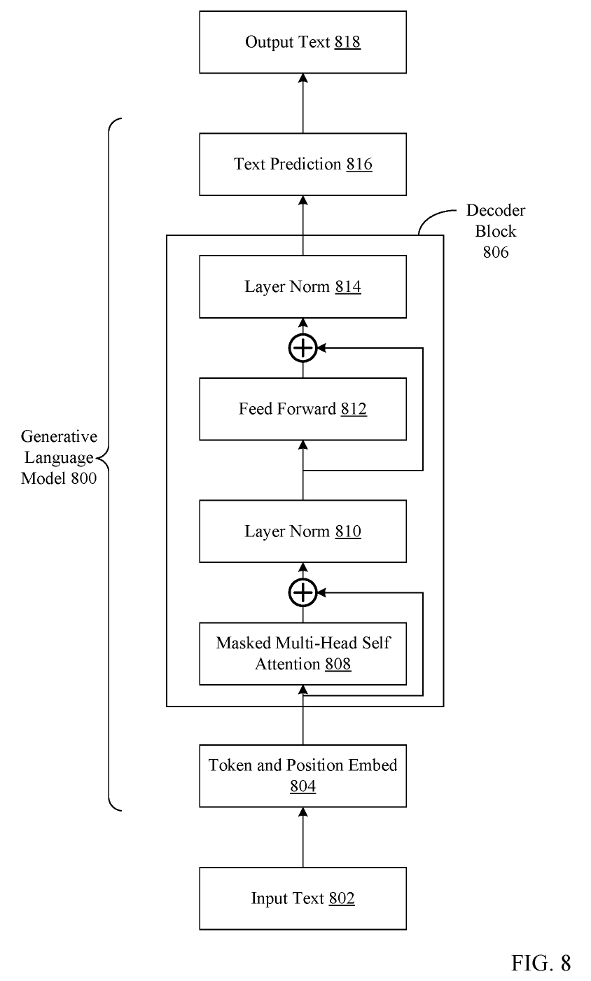

FIG. 8 illustrates an example generative model, such as generative language model 800 that can be employed using the disclosed implementations. Generative language model 800 is an example of a machine learning model that can be used to perform one or more natural language processing tasks that involve generating text, as discussed more below. For the purposes of this document, the term “natural language” means language that is normally used by human beings for writing or conversation.

Generative language model 800 can receive input text 802, e.g., a prompt from a user. For instance, the input text can include words, sentences, phrases, or other representations of language. The input text can be broken into tokens and mapped to token and position embeddings 804 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 804 are processed in one or more decoder blocks 806. Each decoder block implements masked multi-head self-attention 808, which is a mechanism relating different positions of tokens within the input text to compute the similarities between those tokens. Each token embedding is represented as a weighted sum of other tokens in the input text. Attention is only applied for already-decoded values, and future values are masked. Layer normalization 810 normalizes features to mean values of 0 and variance to 1, resulting in smooth gradients. Feed forward layer 812 transforms these features into a representation suitable for the next iteration of decoding, after which another layer normalization 814 is applied. Multiple instances of decoder blocks can operate sequentially on input text, with each subsequent decoder block operating on the output of a preceding decoder block. After the final decoding block, text prediction layer 816 can predict the next word in the sequence, which is output as output text 818 in response to the input text 802 and also fed back into the language model. The output text can be a newly-generated response to the prompt provided as input text to the generative language model.

### Additional Examples

Various examples are described above. Additional examples are described below. One example includes a device implemented method comprising obtaining text chunks of a dataset grouped by period, extracting concepts from the text chunks by period, inducing the extracted concepts into a graph structure, detecting period communities in the graph structure of individual periods, creating period summaries from the detected period communities, determining whether a user query relates to specific periods and/or communities, where the user query relates to specific periods and/or communities, obtaining text answers by mapping the query over relevant period text chunks or relevant period community summaries, and obtaining a final answer for the user query from the obtained text answers.

Another example can include any of the above and/or below examples where the period changes when new data is added to the dataset or wherein the period relates to a time period.

Another example can include any of the above and/or below examples where the method further comprises performing semantic search on the period summaries, wherein performing semantic search comprises embedding the period summaries and the user query, ranking period communities by similarity to the user query, performing LLM relevance tests on period summaries in rank order, and stop taking period communities after a number of successive irrelevant judgements.

Another example can include any of the above and/or below examples where the query type relates to all periods and all communities, further comprising obtaining period summary answers, which map the query over the period community summaries or further comprising obtaining an all-time community over all associated period summaries.

Another example can include any of the above and/or below examples where the method further comprises obtaining the final answer for the user query from the period summary answers.

Another example can include any of the above and/or below examples where extracting entity and/or concept graphs by period comprises extracting entity and/or concept graphs by period and overall.

Another example can include any of the above and/or below examples where the overall entity and/or concept graphs are formed from the period entity and/or concept graphs.

Another example can include any of the above and/or below examples where the mapping the query over relevant period community source texts comprises generating a prompt for a generative model from the mapping.

Another example includes a system comprising storage configured to store computer-readable instructions and a processor configured to execute the computer-readable instructions to obtain text chunks of a dataset from a first period, extract entity and/or concept graphs for the first period, detect communities in the text chunks of the first period, create a first summary from the detected communities of the first period, obtain text chunks of the dataset from a subsequent period, extract entity and/or concept graphs for the subsequent period and not for the first period, detect communities in the text chunks of the subsequent period, create a second summary from the detected communities of the subsequent period, and create an overall summary from the first summary and the second summary.

Another example can include any of the above and/or below examples where the processor is configured to receive a user query and to determine whether the query relates to one of the first period or the subsequent period, or relates to both the first period and the subsequent period, or relates to the first period and another different period.

Another example can include any of the above and/or below examples where the user query relates to the first period, the processor is configured to augment the user query with content from the text chunks of the first period, or wherein the processor is configured to augment the user query with content from the first summary from the first period.

Another example can include any of the above and/or below examples where the user query relates to both the first period and the subsequent period, the processor is configured to augment the user query with content from the text chunks of both the first period and the subsequent period.

Another example can include any of the above and/or below examples where the processor is configured to receive a final answer to the augmented user query.

Another example can include any of the above and/or below examples where extracting entity and/or concept graphs for the subsequent period and not for the first period utilizes fewer resources than extracting entity and/or concept graphs for a combination of the first period and the subsequent period.

Another example can include any of the above and/or below examples where the processor is configured to create an overall summary using graph statistics to detect salient changes over time, and creating summaries of these changes and add them to the first summary of the first period and the second summary of the subsequent period.

Another example can include any of the above and/or below examples where the graph statistics comprise graph embeddings.

Another example can include any of the above and/or below examples where the processor is configured to create summaries of the changes and to add them to the first summary and the second summary.

Another example includes a computer-readable storage medium storing instructions comprising extracting entity and/or concept graphs from text chunks of a dataset from a first period, extracting entity and/or concept graphs from additional text chunks of a dataset from a subsequent period without re-extracting entity and/or concept graphs from text chunks from the first period, detecting period communities in the text chunks of individual periods, creating period summaries from the detected period communities, determining whether a user query relates to specific periods and/or communities, mapping the user query over relevant period community text chunks, and presenting a final answer for the user query from the relevant community text chunks utilizing less computing resources than re-extracting entity and/or concept graphs from text chunks from the first period.

Another example can include any of the above and/or below examples where the first period and the subsequent period are predefined time windows, or wherein the subsequent period is triggered by reception of the additional text chunks.

Another example can include any of the above and/or below examples where the determining indicates that the user query does not relate to specific periods and/or communities, further comprising mapping the user query over higher-level summaries that summarize an all-time community or time period.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A device-implemented method comprising:
obtaining text chunks of a dataset grouped by period;
extracting concepts from the text chunks by period;
inducing the extracted concepts into a graph structure;
detecting period communities in the graph structure of individual periods;
creating period summaries from the detected period communities;
determining whether a user query relates to specific periods and/or communities;
where the user query relates to specific periods and/or communities, obtaining text answers by mapping the query over relevant period text chunks or relevant period community summaries; and,
obtaining a final answer for the user query from the obtained text answers.

2. The method of claim 1, wherein the period changes when new data is added to the dataset or wherein the period relates to a time period.

3. The method of claim 1, further comprising performing semantic search on the period summaries, wherein performing semantic search comprises embedding the period summaries and the user query, ranking period communities by similarity to the user query, performing LLM relevance tests on period summaries in rank order, and stop taking period communities after a number of successive irrelevant judgements.

4. The method of claim 1, where the query type relates to all periods and all communities, further comprising obtaining period summary answers, which map the query over the period community summaries or further comprising obtaining an all-time community over all associated period summaries.

5. The method of claim 4, further comprising obtaining the final answer for the user query from the period summary answers.

6. The method of claim 1, wherein extracting entity and/or concept graphs by period comprises extracting entity and/or concept graphs by period and overall.

7. The method of claim 6, wherein the overall entity and/or concept graphs are formed from the period entity and/or concept graphs.

8. The method of claim 1, wherein the mapping the query over relevant period community source texts comprises generating a prompt for a generative model from the mapping.

9. A system, comprising:
storage configured to store computer-readable instructions; and,
a processor configured to execute the computer-readable instructions to:
obtain text chunks of a dataset from a first period;
extract entity and/or concept graphs for the first period;
detect communities in the text chunks of the first period;
create a first summary from the detected communities of the first period;
obtain text chunks of the dataset from a subsequent period;
extract entity and/or concept graphs for the subsequent period and not for the first period;
detect communities in the text chunks of the subsequent period;
create a second summary from the detected communities of the subsequent period; and,
create an overall summary from the first summary and the second summary.

10. The system of claim 9, wherein the processor is configured to receive a user query and to determine whether the query relates to one of the first period or the subsequent period, or relates to both the first period and the subsequent period, or relates to the first period and another different period.

11. The system of claim 10, where the user query relates to the first period, the processor is configured to augment the user query with content from the text chunks of the first period, or wherein the processor is configured to augment the user query with content from the first summary from the first period.

12. The system of claim 10, where the user query relates to both the first period and the subsequent period, the processor is configured to augment the user query with content from the text chunks of both the first period and the subsequent period.

13. The system of claim 12, wherein the processor is further configured to receive a final answer to the augmented user query.

14. The system of claim 13, wherein the extracting entity and/or concept graphs for the subsequent period and not for the first period utilizes fewer resources than extracting entity and/or concept graphs for a combination of the first period and the subsequent period.

15. The system of claim 9, wherein the processor is configured to create the overall summary using graph statistics to detect salient changes over time, and to create summaries of these changes and add them to the first summary of the first period and the second summary of the subsequent period.

16. The system of claim 15, wherein the graph statistics comprise graph embeddings.

17. The system of claim 15, wherein the processor is configured to create summaries of the changes and to add them to the first summary and the second summary.

18. A computer-readable storage medium storing instructions comprising:
extracting entity and/or concept graphs from text chunks of a dataset from a first period;
extracting entity and/or concept graphs from additional text chunks of a dataset from a subsequent period without re-extracting entity and/or concept graphs from text chunks from the first period;
detecting period communities in the text chunks of individual periods;
creating period summaries from the detected period communities;
determining whether a user query relates to specific periods and/or communities;
mapping the user query over relevant period community text chunks; and,
presenting a final answer for the user query from the relevant community text chunks utilizing less computing resources than re-extracting entity and/or concept graphs from text chunks from the first period.

19. The computer-readable storage medium of claim 18, wherein the first period and the subsequent period are predefined time windows, or wherein the subsequent period is triggered by reception of the additional text chunks.

20. The computer-readable storage medium of claim 18, where the determining indicates that the user query does not relate to specific periods and/or communities, further comprising mapping the user query over higher-level summaries that summarize an all-time community or time period.
